(19) United States
(12) Patent Application Publication
(10) Pub. No.: US 2006/0149480 A1
(43) Pub. Date: Jul. 6, 2006

(54) Method of making combination medicament and medicament made thereby

(76) Inventor: James E. Lundeen, Cleveland Heights, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/066,595

(22) Filed: Feb. 25, 2005

Related U.S. Application Data
(60) Provisional application No. 60/547,944, filed on Feb. 26, 2004.

(51) Int. Cl. G06F 19/00

(52) U.S. Cl. 702/19; 705/3

(57) ABSTRACT

Method of making a medicament, and a medicament made thereby, including identifying at least one morbid condition including a plurality of manifestations for which a plurality of distinct active ingredients may be prescribed for treatment of each of the respective plurality of manifestations; determining a combination of at least two of the plurality of distinct active ingredients prescribed for treatment of each of the at least one condition, in which the combination may be taken together for such treatment of the respective plurality of manifestations; determining an effective dosage and content ratio of each of the distinct active ingredients in the combination; and preparing a medicament comprising the combination, wherein a ratio of each distinct active ingredient in the medicament substantially corresponds to the determined effective dosage and content ratio. The method similarly may be applied to co-morbid conditions.

### CROSS-REFERENCE TO RELATED APPLICATION

The present application claims priority under 35 U.S.C. 119(e) to U.S. Provisional Application No. 60/547,944, filed Feb. 26, 2004, the entirety of which is hereby incorporated by reference herein.

### BACKGROUND

1. Technical Field

The present invention relates to methods of preparing medicaments comprising a plurality of active ingredients for use in treating either at least one condition including a plurality of manifestations, or the manifestations of at least two co-morbid conditions. More particularly, the present invention relates to identifying commonly co-occurring manifestations of a condition or co-morbid conditions, determining a plurality of active ingredients used to treat such conditions, and combining these active ingredients into a medicament.

2. Related Art

Patients frequently suffer from a constellation of symptoms resulting from an ailment, or from a combination of ailments each with its own constellation of symptoms. As a result, under current practices, patients are often required to administer to themselves many different medications, each with its usually single active ingredient, each separately manufactured and supplied, each separately prescribed and each having its own particular dosage regimen. Many patients, particularly elderly patients, may take upwards of a half-dozen, a dozen or even more separate medications every day.

These current practices are expensive, confusing to patients, and wasteful of the resources of pharmaceutical companies. The practices are expensive and wasteful of resources because each medication must be separately compounded, prepared, packaged, shipped, stored, prescribed and sold, and all of these activities must be carried out in accordance with state and federal drug laws. Each of these steps must be repeated for each of the myriad medications which may be prescribed for any individual patient.

These current practices, being confusing to patients, give rise to the possibility and even likelihood of errors in dosage on the part of the patient. It is well known that elderly patients in particular can become confused by the plurality of medications they are often required to self-administer. Such confusion can result in dangerous under- or over-dosing, as well as additional expense when medications must be replaced as a result. For patients with chronic, multi-symptom conditions, a similar situation can exist, resulting in the same excess expense and possible confusion and dangerous errors.

In most such cases, the number of different active ingredients cannot be reduced, since each may be necessary for the treatment of one or more individual symptoms or conditions. However, because physicians are often consulted for only one, some, or less than all, of a patient's conditions, the dosages of the medications prescribed to a patient may not be optimum for all the patient's conditions, when considered as a whole. For example, a person with back problems may be over-dosed with analgesic medication for pain in an effort to reduce pain and muscle spasms. As a result, the patient may be immobilized by the over-dose of analgesic, and thereby prevented from conducting the ordinary business of life. Similarly, in many cases, commonly co-occurring symptoms may not be recognized as arising from the same source. As a result, each symptom may be treated separately, thus resulting in overlapping dosages and possible over-dosing of the combination of active ingredients. As used herein, the term “over-dose”, and similar terms, refers to dosing with more of a given active ingredient than would be needed to treat a single symptom for which the active ingredient would otherwise be prescribed, and is not intended to be limited to the common usage of “overdose” as a fatal dose, although it is possible such “over-dose”, as presently defined, could be fatal.

As a result of these current practices and conditions, there is an urgent need for a new way of prescribing, manufacturing and administering pharmaceutical active ingredients.

### SUMMARY

In one embodiment, the present invention relates to a method of making a medicament, including steps of:

identifying at least one morbid condition including a plurality of manifestations for which a plurality of distinct active ingredients may be prescribed for treatment of each of the respective plurality of manifestations; determining a combination of at least two of the plurality of distinct active ingredients prescribed for treatment of each of the at least one condition, in which the combination may be taken together for such treatment of the respective plurality of manifestations;

determining an effective dosage and content ratio of each of the distinct active ingredients in the combination; and

preparing a medicament comprising the combination, wherein a ratio of each distinct active ingredient in the medicament substantially corresponds to the determined effective dosage and content ratio.

In another embodiment, the present invention relates to a method of making a medicament, including steps of:

identifying at least two co-morbid conditions for which a plurality of distinct active ingredients may be prescribed for substantially simultaneous treatment of the at least two co-morbid conditions;

determining a combination of at least two of the plurality of distinct active ingredients commonly prescribed for treatment of the at least two co-morbid conditions, in which the combination may be taken together for treatment of the at least two co-morbid conditions;

determining an effective dosage and content ratio of each of the distinct active ingredients in the combination; and

preparing a medicament comprising the combination, wherein a ratio of each distinct active ingredient in the medicament substantially corresponds to the determined effective dosage and content ratio.

In another embodiment, the present invention relates to a medicament, including a plurality of active ingredients, wherein at least two of the plurality of active ingredients are prescribed for separate co-morbid conditions, wherein each of the plurality of active ingredients is provided in an effective dosage and content ratio effective to treat the separate co-morbid conditions in a patient presenting the co-morbid conditions.

Thus, the present invention addresses the problem of reducing expense, complexity and danger resulting from possible drug interactions which exists in the current state of the art in which individual medications are prescribed separately for individual symptoms or conditions, and in which in some cases are prescribed and/or administered by practitioners unaware of other active ingredients the patient may be taking at the same time. The present invention addresses this problem by providing a method of making a medicament, and the medicament so made, in which the medicament includes a plurality of active ingredients in one dosage form or in a relatively small number of dosage forms, compared to the large number of individual dosage forms which would be required if each of the active ingredients was separately prescribed as in the prior art.

### BRIEF DESCRIPTION OF THE DRAWINGS

FIG. 1 is a schematic flow diagram illustrating a method in accordance with one embodiment of the present invention.

FIG. 2 is a schematic flow diagram illustrating a method in accordance with another embodiment of the present invention.

### DETAILED DESCRIPTION

In one embodiment, the present invention relates to a method of making a medicament, including steps of identifying at least one morbid condition including a plurality of manifestations for which a plurality of distinct active ingredients may be prescribed for treatment of each of the respective plurality of manifestations; determining a combination of at least two of the plurality of distinct active ingredients prescribed for treatment of each of the at least one condition, in which the combination may be taken together for such treatment of the respective plurality of manifestations; determining an effective dosage and content ratio of each of the distinct active ingredients in the combination; and preparing a medicament comprising the combination, wherein a ratio of each distinct active ingredient in the medicament substantially corresponds to the determined effective dosage and content ratio.

In another embodiment, the present invention relates to a method of making a medicament, including steps of identifying at least two co-morbid conditions for which a plurality of distinct active ingredients may be prescribed for substantially simultaneous treatment of the at least two co-morbid conditions; determining a combination of at least two of the plurality of distinct active ingredients commonly prescribed for treatment of the at least two co-morbid conditions, in which the combination may be taken together for treatment of the at least two co-morbid conditions; determining an effective dosage and content ratio of each of the distinct active ingredients in the combination; and preparing a medicament comprising the combination, wherein a ratio of each distinct active ingredient in the medicament substantially corresponds to the determined effective dosage and content ratio. Each of the foregoing methods is described in detail in the following, with reference to the accompanying drawings.

An effective or efficacious amount is an amount greater than zero that has a desired or desirable pharmacological effect on a patient to whom the medicament is administered. The terms “medicament” or “active ingredient” as used herein, include prescription-only medicines, over-the-counter medicines (OTC), herbal remedies, vitamins, bioactives, health supplements, and the like, and combinations of two or more thereof, any of which may be prescribed by a physician treating a patient presenting a combination of conditions for which a combination of two or more active ingredients may be required for treatment. As used herein, a medicament may include a mixture or combination of two or more active ingredients, each of which may be indicated for, prescribed for and/or administered in the treatment of an illness, a condition, a combination of conditions, co-morbid conditions, a disease, a combination of diseases or a syndrome or any manifestation of any of the foregoing.

In carrying out the method of the present invention, the practitioner obtains data relating to use of medicaments for treatment of conditions. Factors to be considered include both physician and patient demographics, specific medical conditions treated, medicaments prescribed, provided, sold, distributed and/or used, effective dosages, dosages actually prescribed and used, and any related information available and in some way relevant to the subject matter.

In one embodiment, the method includes surveying a group of medical practitioners, physicians, surgeons, pharmacists, pharmacologists, nurses, hospital administrators, and the like, and combinations or groups of two or more thereof (collectively “physicians” hereinafter). The survey may query for information regarding prescriptions, drug interactions, drug allergies, common dosages, dosage amounts over time, tolerances, age, gender, patient conditions, side effects, ancillary symptoms associated directly or indirectly with a main condition, and the like, and combinations of two or more thereof, which may be referred to collectively as “relevant information”.

The relevant information may be obtained from the appropriate source (see below also) and data mined to determine correlations, commonalities, trends, similarities and the like, in the prescription of two or more active ingredients. For example, a commonality may be that for a group of patients diagnosed with a particular condition, a particular portion of the group of the patients may have been prescribed similar groups of medicines, and the amounts of those medicines prescribed may be correlated. Other correlations may include, for example, dosage regimens, additional medicines, increases or decreases of dosage amounts over time, and the like.

Computerized databases can be useful tools in determining and managing appropriate care for patients, including the foregoing considerations and, in particular, in locating relevant information for use in the methods of the present invention. All states have laws and regulations that govern the distribution and handling of controlled substances and other pharmaceuticals as well as the provision of medical and pharmaceutical care. States' laws generally must balance the promotion of the safe use of controlled substances for the provision of medical care and services with the need to impede illegal and harmful activities involving these pharmaceuticals. Prescription monitoring programs are tools used by states to assist in the achievement of these goals.

One source of computerized information relating to drugs and dosage forms is The National Drug Code Directory (NDC). The NDC System was originally established as an essential part of an out-of-hospital drug reimbursement program under Medicare. The NDC serves as a universal product identifier for human drugs. The current edition of the National Drug Code Directory is limited to prescription drugs and a few selected OTC products. The NDC can be accessed on the Internet at http://www.fda.gov/cder/ndc/.

A major goal of many prescription monitoring programs is the provision of information and feedback to prescribers, pharmacists and the public. Programs can provide prescribers with information on their own prescribing records and have assisted prescribers in some states in identifying individuals who forge or illicitly obtain prescriptions. Information on and analysis of prescribing trends in the states can also be generated and disseminated. Such analysis may, for example, provide comparative information between geographic regions, medical specialties or drug classes.

Prescription monitoring programs gather a large quantity of data on pharmaceutical prescribing patterns, and include data on individual patients, physicians and pharmaceuticals. This data can be used to obtain information on commonly prescribed medications, and can provide such data on a patient-by-patient basis without revealing the identity of individual patients or physicians. Analysis of such data by commonly available statistical programs and methods can reveal patterns of commonly-prescribed medications and commonly-prescribed dosages of such medications. It is the data reduction, review and resulting preparation of new combinations of usually old medications to which the present invention is directed.

There are several large prescription databases with information on privately insured individuals, but they have relatively few people over age 65. That population is growing, however, and its use of prescription medications is rising briskly.

One source of such relevant information about medicaments, patients and prescribing information is the U.S. Department of Veterans Affairs (VA), which maintains large databases of inpatient and outpatient health care utilization. Recently, it has become possible to link pharmacy data to VA patient-level utilization data. The VA patient population is of considerable interest due to its large size and nationwide representation. Vulnerable populations, such as people with low incomes, disabilities, or mental health and substance abuse problems, are present in substantial numbers. Although many VA patients are elderly men, the numbers of younger veterans and women allow for analysis of these groups as well.

The following brief description of the VA procedures for prescribing medications and the computerized systems utilized for both carrying out the prescribing and for creating and controlling records thereof is provided as an exemplary database from which data relating to prescription and dosage can be mined in carrying out the present invention. This description is merely exemplary, is not intended to limit the invention in any way. It is considered that similar systems are in place in many large hospitals, HMOs, insurance companies and similar providers. This description illustrates how a database providing prescribing and related information may be created, as well as illustrating the contents of the database.

The VA stores patient medical records in electronic format. The records are accessed through the Computerized Patient Record Systems (CPRS). CPRS is one component of the larger clinical and management information system known as the Veterans Health Information Systems and Technology Architecture (VISTA). Providers use CPRS to review and update patient medical records and to place orders for medications, procedures, and tests. Many data files and applications within VISTA support CPRS and its graphical user interface (CPRS-GUI).

Providers with authorization to make orders are given access to the CPRS pharmacy order screen. In the outpatient setting, after logging into CPRSGUI, the provider selects the Add Orders Menu to order lab tests, radiological tests, medications, medical supplies, and other items. If the outpatient medication menu is selected, the medication order box appears. The provider selects a pharmacy orderable item from the alphabetical list of generic and branded products (e.g., METOPROLOL TARTRATE TAB) in the medication order box. When a particular item is selected, the order dialog screen appears. It lists the available dosages (e.g., 12.5 mg, 25 mg, 50 mg, 100 mg, and 200 mg). The price per dispensed unit corresponding to each dosage will appear along with the associated route of administration, or method of consumption. Routes of administration include intravenous (IV), oral (PO/ORAL), and many others. Only the route that applies to a specific dosage form will appear when the product is selected. If a tablet is chosen, for example, only PO/ORAL will appear. After choosing the dosage and route, the provider specifies the schedule of administration. The schedule is the frequency of consumption, such as twice per day (BID) or three times per day (TID). The provider can also enter additional instructions for the pharmacist or patient in a free-text field. These comments appear with the dosing instructions.

Depending on the product selected, the CPRS-GUI may flash messages associated with the product. The messages may suggest specific days supplied, provide information about product restrictions, or give information regarding policy or pricing. A message about days supplied might encourage the provider to choose particular values. If there is no such message, then he or she must specify the number of days supplied and the number of refills deemed appropriate. VA pharmacies customarily fill either 30-or 90-day supplies of routine medications. The total quantity dispensed (e.g., tablets, vials) is automatically calculated by VISTA based on the dosage, schedule, and days supplied selected, although it may be altered manually by the provider. The provider then specifies the pickup method of the prescription; options include mail-order, the medical center pharmacy, and in-clinic (e.g., for vaccinations). Finally, the priority of the prescription is specified as routine, urgent, or immediate.

The dosing instructions field is automatically generated based on product information in VISTA files and order elements selected by the provider. The order software calculates the quantity to be consumed at each dose based on the chosen values of strength, dosage, and schedule. It then attaches any free-text comment the provider has made. The result is a statement in plain English. For example, an order for METOPROLOL TARTRATE tabs, 50 mg strength, PO/ORAL route, with BID schedule and a free-text instruction to consume the drug after meals would yield the following instructions: “METOPROLOL TARTRATE TAB 50 MG. TAKE ONE TABLET BY MOUTH TWICE A DAY AFTER MEALS.”

The final steps involve verification by the provider and pharmacist. After reviewing the order elements, the provider clicks the “accept” button. This causes the order to appear in the patient's list of medications, a different tab within the CPRS-GUI. The provider then electronically signs the order. The order appears in an appropriate VISTA file, referred to as the Pending Prescriptions Menu. A pharmacist finishes the order by checking it for consistency. Prescriptions destined for mail-order delivery are dispatched to one of seven VA Consolidated Mail Outpatient Pharmacies (CMOPs). Otherwise the prescription is filled, labeled, and dispensed via the facility's pharmacy.

VA pharmacists are not required to follow every aspect of prescription orders. Within limits, a pharmacist may change the strength and quantity supplied of a medication. For example, an order for 150 tablets at 50 mg strength might be filled as 75 tablets at 100 mg strength. The pharmacist would then alter the dosing instructions as well to indicate splitting the scored tablet using a splitting device provided by the pharmacy.

The prescribing sequence for inpatient care is slightly different and depends on whether the order is intravenous (IV) or unit dose (UD). For an IV order, the provider can specify the solution (active or inert), the additive (medication), infusion rate, and priority. For a UD order, the provider specifies the dosage, route, schedule, comment, and priority. There is also a checkbox to indicate that an additional dose is to be given immediately upon receiving the order, rather than waiting until the next regularly scheduled time as indicated on the order form.

The CPRS-GUI is a dynamic system. Providers have access to a Quick Orders Tabs for inpatient and outpatient medications. They feature commonly used combinations of strengths, routes of administration, quantities supplied, and refills for the most common VA drug classes and other selected medications. If a provider chooses any of these combinations, the order dialog screen is automatically populated with most information required for the order; the provider need only specify changes such as pickup method (for outpatient prescriptions) and priority, and then accept and sign the order.

As shown by the foregoing description of a state-of-the-art prescribing system, the records relating to prescriptions are maintained in great detail and are readily available. Using commonly available data mining techniques, in accordance with the present invention, data relating to patterns of prescribing, dosages and changes thereto, morbidity conditions commonly occurring, costs, etc. can be obtained from databases such as the VA data described above.

Morbid Conditions Including Multiple Manifestations

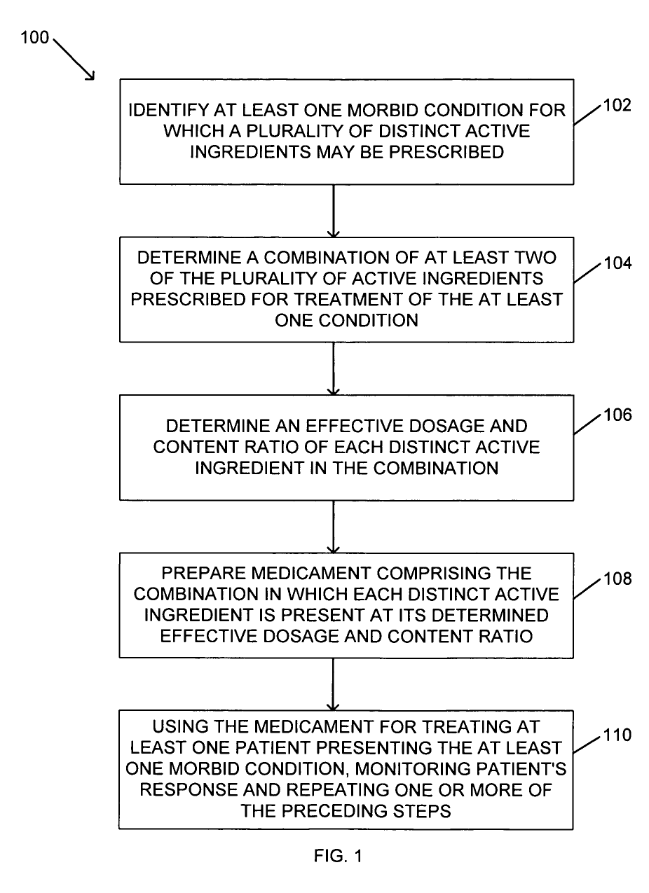

In the one embodiment of the method of the present invention, data such as that described above, obtained for example from a survey of physicians and/or pharmacists or from a database such as that of the VA, is obtained and utilized to carry out the steps of a first embodiment of the present invention. This embodiment is illustrated schematically in FIG. 1, and includes steps of identifying at least one medical condition, including multiple manifestations, for which a plurality of distinct active ingredients may be prescribed for treatment of the multiple manifestations of the at least one condition (step 102 in FIG. 1) and in determining a combination of at least two of the plurality of distinct active ingredients commonly prescribed for treatment of the multiple manifestations of the at least one condition, in which the combination may be taken together for treatment of the multiple manifestations of the at least one condition (step 104 in FIG. 1). As shown in FIG. 1, in this embodiment of the invention, following the steps 102 and 104, step 106, determining an effective dosage and content ratio of each distinct active ingredient in the combination is carried out. Based on the information obtained in the steps 102, 104 and 106, in the next step of this embodiment of the invention, step 108, a medicament is prepared, in which the medicament includes the combination of active ingredients in which each distinct active ingredient is present substantially at its effective dosage and content ratio, as determined in the step 106.

In one embodiment of the invention, following preparation of the medicament in step 108, as illustrated in step 110 of FIG. 1, the medicament may be used for treating at least one patient presenting the at least one morbid condition, monitoring the patient's response and repeated one or more of the preceding steps 102, 104, 106 and/or 108, as needed to obtain the desired therapeutic effect. Step 110 may be carried out by other than the person carrying out the first four steps 102, 104, 106 and 108, and so is optional in this embodiment of the invention.

The method includes identifying at least one morbid condition including a plurality of manifestations for which a plurality of distinct active ingredients may be prescribed for treatment of each of the respective plurality of manifestations. For example, a patient presenting with a herniated lumbar disk may also be suffering from other conditions which are not always recognized as co-occurring or resulting from the herniated lumbar disk. A patient with a herniated lumbar disk is most likely to experience pain, for which an analgesic, e.g., a narcotic analgesic, may be prescribed. As a result of the nerve stimulation associated with the herniated lumbar disk, the patient may also present muscle spasms, for which a skeletal muscle relaxant may be prescribed. Thus, the one condition, a herniated lumbar disk, is identified, for which a plurality of distinct active ingredients may be prescribed.

In one embodiment, the step of identifying comprises (a) polling a plurality of practitioners for relevant information, (b) reviewing a database containing relevant information, or a combination of one or more of both (a) and (b), wherein the relevant information relates to identity of the at least one active ingredient, either or both of the at least two co-morbid conditions, the dosage of each at least one active ingredient and any interactions between any combination of the at least one active ingredient. In one embodiment, one or more suitable statistical and/or mathematical algorithm is used to reduce the data, obtain correlations and other relevant information from the data, and to thereby assist in the identification of manifestations of the at least one morbid condition which may be treated according to the method of the present invention. Suitable statistical and/or mathematical analysis methods and programs are known to those in the art, and may include software programs such as, for example, SPSS® (Chicago, Ill.), ANALYSE-IT® (Leeds, UK) and NCSS Statistical Software (Kaysville, Utah).

The data analysis may be based on a plurality of factors, which may include, for example, any combination of the following: patient demographics, such as age, gender, ethnic background, medical history, specific medical conditions past and/or present both including and in addition to the conditions of direct interest, economic capacity, geographical location, and the like; economic considerations relevant to the pharmaceutical composition under consideration; supply and availability considerations relevant to the pharmaceutical composition under consideration; dosage regimens relevant to the pharmaceutical composition under consideration; interaction of the specific active ingredients and secondary ingredients relevant to the pharmaceutical composition under consideration; ownership interests in intellectual property rights associated with the compositions and/or active ingredients; and other similar factors as determined by the persons, such as health care professional, conducting the determination and carrying out the method of the present invention. Relevant factors can be identified and selected readily by those of skill in the art.

Based on the identified plurality of manifestations, the method includes determining a combination of at least two of the plurality of distinct active ingredients prescribed for treatment of each of the at least one condition, in which the combination may be taken together for such treatment of the respective plurality of manifestations. In one embodiment, the step of determining a combination comprises selecting at least one member of a group of active ingredients effective for treatment of at least one of the plurality of manifestations related to or co-occurring in the at least one condition. Thus, for example, there are many different analgesics available for possible use in the method, and an appropriate one or more of them needs to be selected by the practitioner of the method, based on all the relevant information as well as the practitioners' own knowledge and skill.

In the prior art, the various active ingredients would be prescribed separately.

The following provides an example of the process of this embodiment of the present invention, and is intended to be exemplary and not limiting of the scope of the invention, which is only limited by the scope of the claims appended hereto.

The analgesic may be, for example, PERCOCET® or a generic equivalent, and the skeletal muscle relaxant may be, for example, SOMA® or a generic equivalent. Each of these medicaments include an active ingredient, together with various excipients, stabilizers, etc. Each of these medicaments may be prescribed for, e.g., four times a day administration. PERCOCET®, for example, is provided in dosage sizes of 2.5 mg, 5 mg, 7.5 mg and 10 mg with, for example, the 5 mg dosage being most often prescribed, and is normally taken once every six hours, i.e., four times a day. SOMA®, for example, is provided in a dosage size of 350 mg, and is normally taken four times a day.

In accordance with one embodiment of the present invention, a new medicament is prepared for the treatment of these symptoms of a herniated lumbar disk. This exemplary medicament includes the active ingredients of both PERCOCET® and SOMA®. In one embodiment, the new medicament includes, for example, 5 mg. of the active ingredient of PERCOCET® and 350 mg of the active ingredient of SOMA®, which would be taken four times a day. As an alternative embodiment, a new medicament could be prepared which includes, for example, 10 mg. of the active ingredient of PERCOCET® and 350 mg of the active ingredient of SOMA®, which would also be taken four times a day. Thus, the benefits of reduced complexity for the patient's dosage, reduced costs in manufacturing, marketing, prescribing, dispensing and handling the medicament would be obtained, as a result of the combination of these drugs in accordance with this embodiment of the present invention.

The present inventor has discovered that, patients with a herniated lumbar disk, in addition to the above-described symptoms, often present additional symptoms which are frequently overlooked in relation to the herniated lumbar disk. These additional symptoms include one or more of bowel and/or bladder urgency and/or incontinence, irritable bowel syndrome, erectile dysfunction and depression.

As a result of this discovery, the present inventor identifies at least one medical condition for which a plurality of distinct active ingredients may be prescribed for treatment of the conditions.

In accordance with another embodiment of the present invention, a new medicament is prepared for the treatment of both the above-described “standard” symptoms and these additional symptoms resulting from the herniated lumbar disk. In one embodiment, in addition to the medicament which contains both an analgesic and a muscle relaxant, the medicament is formulated to further comprise an active ingredient for treating the bowel/bladder urgency and/or incontinence and depression. In one embodiment, this active ingredient for treating the bowel/bladder urgency and/or incontinence is imipramine. Imipramine is a tricyclic antidepressant with general pharmacological properties similar to those of structurally related tricyclic antidepressant drugs such as amitriptyline and doxepin. Imipramine has been used for treating enuresis in children aged 5 years and older. The present inventor has discovered that imipramine is useful in treating adult and elder bowel/bladder urgency and/or incontinence, as well as its more usual use in treating depression.

Imipramine may be provided in 50 mg tablets, which may be taken 3 times a day. In one embodiment, imipramine is combined in a single dosage form with the analgesic and muscle relaxant. In one embodiment, in which the analgesic and muscle relaxant are intended to be dosed four times per day, the imipramine is contained in the dosage form in a quantity sufficient to provide the same total dosage as in 50 mg tablets three times per day, by adjusting the amount of imipramine to (50×3)/4=37.5 mg per dosage.

The present inventor has discovered, and as disclosed in the present inventor's copending U.S. patent application Ser. No. 10/970,164, filed 21 Oct., 2004 and entitled “Method for Treating Gastrointestinal Disorder Including Irritable Bowel Syndrome”, when administering imipramine, it is highly beneficial to co-administer a stool softener. This is because imipramine can cause constipation and/or diarrhea. As disclosed in the '164 application, the use of a stool softener together with imipramine unexpectedly results in moderation of these effects of imipramine. As disclosed in the '164 application, the dosage of stool softener, when administered together with imipramine, is about 200 mg per day or greater. In one embodiment, the stool softener is dioctyl sodium sulfosuccinate, or docusate sodium, available under the name COLACE® or SURFAK® as an over the counter, nontoxic stool softener.

Docusate sodium individual dosage size ranges from 50 mg, 100 mg and 250 mg are adjusted to be combined with the analgesic, muscle relaxant and imipramine. In one embodiment, the docusate sodium is administered together with the imipramine at a dosage of about 200 mg per day or greater if needed, and in another embodiment, with the imipramine at a dosage of about 300 mg per day or greater.

The present inventor has discovered that, in addition to the pain, muscle spasms, bowel/bladder urgency and/or incontinence and depression discussed above, patients suffering from a herniated lumbar disk frequently manifest erectile dysfunction as well. The mechanism of this effect is not well understood, but it has been anecdotally associated with the herniated lumbar disk in many patients of the present inventor.

Accordingly, in another embodiment, in addition to the analgesic and muscle relaxant, an active ingredient to treat the erectile dysfunction (ED) is added to the combination of analgesic and muscle relaxant. In another embodiment, in addition to the analgesic, muscle relaxant, imipramine and stool softener, an active ingredient to treat the ED is added to the combination.

In one embodiment, the active ingredient used to treat the erectile dysfunction is the active ingredient of one or more of VIAGRA® (sildenafil citrate), CIALIS® (tadalafil) or LEVITRA® (vardenafil hydrochloride).

VIAGRA® usually is provided in 25 mg, 50 mg and 100 mg dosages. CIALIS® usually is provided in a 20 mg dosage. LEVITRA® usually is provided in 2.5 mg, 5 mg, 10 mg, and 20 mg dosages.

Since each of these drugs for treating ED are normally only taken once a day, the dosage must be adjusted and/or a separate dosage form provided, to include the ED treatment with the above described treatments for pain, muscle spasms, bowel/bladder urgency and/or incontinence and depression. In one embodiment, the drug for treating ED is co-packaged with the medicament comprising a combination of at least two of the plurality of distinct active ingredients.

Based on the foregoing considerations, a combination of at least two of the plurality of distinct active ingredients prescribed for treatment of the at least condition, in which the combination may be taken together for treatment of the at least one condition.

Based on the foregoing considerations, a dosage ratio for each of the distinct active ingredients in the combination may be determined. In one embodiment, the step of determining an effective dosage and content ratio comprises reviewing dosage data for each active ingredient used for treatment of each respective manifestation, obtaining information on effective dosage for treatment of each respective manifestation, analyzing the dosage data to obtain the average, mean and/or mode of dosages commonly prescribed for treatment of each respective manifestation, comparing the dosage data for each active ingredient in the combination, and obtaining the content ratio for the plurality of active ingredients.

Thus, in one embodiment in accordance with the present invention, a new medicament is provided which includes a plurality of active ingredients, each directed to a different condition. As a result, a medicament may be prepared comprising one or more of the foregoing combinations, in which a ratio of each distinct active ingredient in the medicament substantially corresponds to the determined dosage ratio.

In one embodiment, at least one of the active ingredients has at least a five year history of clinical use for treatment of at least one of the plurality of manifestations. Using active ingredients having at least a five year history of clinical use provides assurance that extensive data will be available based on the experience of a plurality of practitioners. In one embodiment, all of the active ingredients have at least a five year history of clinical use for treatment of at least one of the plurality of manifestations.

In one embodiment, one or more of the active ingredients used in accordance with the present invention may be provided in a time-release form. Suitable time-release forms are known to those of skill in the art. Use of time release forms may be used to “bridge the gap” between dosage regimens of the plurality of active ingredients, when for example, one must be taken only once a day, while others must be spread out into multiple doses over the day.

In summary, in the foregoing embodiment of the present invention, a method of making a medicament is provided, including steps of identifying at least one medical condition for which a plurality of distinct active ingredients may be prescribed for treatment of the at least one condition; determining a combination of at least two of the plurality of distinct active ingredients prescribed for treatment of the at least one condition, in which the combination may be taken together for treatment of the at least one condition; determining a dosage ratio of each of the distinct active ingredients in the combination; and preparing a medicament comprising the combination, wherein a ratio of each distinct active ingredient in the medicament substantially corresponds to the determined dosage ratio.

In another embodiment of the present invention, by preparing the medicament comprising the combination, a synergistic effect is obtained, in that the dosage of one or more of the distinct active ingredients in the combination can be reduced relative to the amount of that distinct active ingredient if used in the absence of the other distinct active ingredients in the combination. For example, in one embodiment, using the examples set forth above, due to the use of the muscle relaxant, the quantity of analgesic needed to obtain the desired effect can be reduced. In the absence of the muscle relaxant, additional analgesic is frequently required, due to the exacerbation of pain resulting from the muscle spasms. Although not to be bound by theory, this is thought to be the result of feedback mechanisms. Combining the dosages of analgesic and muscle relaxant can reduce the total quantity of medicament which must be administered, thus constituting a synergistic effect. Similar effects are believed to result from the combination of additional ingredients, such as those exemplified above.

In one embodiment, the method further includes using the prepared medicament for treating at least one patient presenting the at least one morbid condition, monitoring response of the at least one patient and repeating one or more of the preceding steps. Thus, based on the experience of the practitioner in the practice of the invention, the method can be repeated and the medicament further refined by, e.g., adjusting the dosages and/or content ratios of the active ingredients. for example, it may be found that a given combination provides a synergistic effect, and that a lower dosage of one or more of the active ingredients in the combination can be reduced. In that case, the medicament may be reformulated. On the other hand, it may be found that there is an unexpected adverse effect resulting from interactions between two ingredients, which had not been previously recognized. In this case as well, the medicament may be reformulated.

In one embodiment, all of the active ingredients in this embodiment of the method are prescription-only pharmaceutical agents. In another embodiment, a plurality of the active ingredients in this embodiment of the method are prescription-only pharmaceutical agents. In another embodiment, at least one of the active ingredients in this embodiment of the method are prescription-only pharmaceutical agents.

In one embodiment, the step of identifying includes identifying at least two co-morbid conditions, each comprising at least one manifestation. Such co-morbid conditions and the embodiments of the present invention applicable thereto are discussed in the following.

Multiple Co-Morbid Conditions

In another embodiment, the present invention relates to a method of making a medicament in which the at least one condition includes at least two co-morbid conditions for which a plurality of distinct active ingredients may be prescribed for substantially simultaneous treatment of the at least two co-morbid conditions. This embodiment is similar to the first embodiment, except that in this embodiment the manifestations treated result from co-morbid conditions that may or may not be related. In one embodiment, the co-morbid conditions are not related by a common causative basis, but have been found empirically to frequently co-occur. In another embodiment, the co-morbid conditions have at least one common causative basis, and thus frequently co-occur since the cause of one may contribute to causing another.

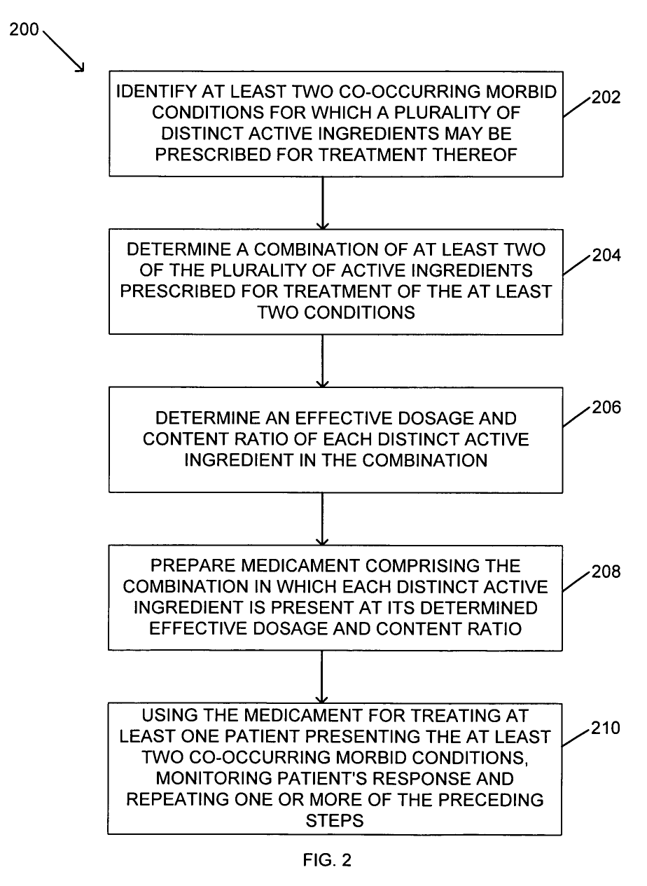

In a second embodiment of the method of the present invention, data such as that described above, obtained for example from a survey of physicians and/or pharmacists or from a database such as that of the VA, is obtained and utilized to carry out the steps of the method, in which at least two co-morbid conditions are to be treated and an appropriate medicament therefor prepared. This embodiment is illustrated schematically in FIG. 2, and includes steps of identifying at least two co-morbid conditions for which a plurality of distinct active ingredients may be prescribed for substantially simultaneous treatment of the at least two co-morbid conditions (step 202 in FIG. 2) and in determining a combination of at least two of the plurality of distinct active ingredients commonly prescribed for treatment of the at least two co-morbid conditions, in which the combination may be taken together for treatment of the at least two co-morbid conditions (step 204 in FIG. 2). As shown in FIG. 2, in this embodiment of the invention, following the steps 202 and 204, a step 206, determining an effective dosage and content ratio of each distinct active ingredient in the combination is carried out. Based on the information obtained in the steps 202, 204 and 206, in the next step of this embodiment of the invention, step 208, a medicament is prepared, in which the medicament includes the combination of active ingredients in which each distinct active ingredient is present substantially at its effective dosage and content ratio, as determined in the step 206.

In one embodiment of the invention, following preparation of the medicament in step 208, as illustrated in step 210 of FIG. 2, the medicament may be used for treating at least one patient presenting the at least one morbid condition, monitoring the patient's response and repeated one or more of the preceding steps 202, 204, 206 and/or 208, as needed to obtain the desired therapeutic effect. Step 210 may be carried out by other than the person carrying out the first four steps 202, 204, 206 and 208, and so is step 210 is optional in this embodiment of the invention.

In this embodiment, a medicament may be prepared which contains a group of active ingredients combined into a single dosage form, in which at least some of the active ingredients are normally separately used for treating each distinct but often co-morbid conditions. Thus, for example, where a patient presents high blood pressure, high cholesterol and diabetes, a single medicament can be created to treat each of these co-morbid conditions. In one embodiment, the co-morbid conditions are recognized as being inter-related by causation. In another embodiment, the co-morbid conditions are not generally recognized as being in any way inter-related by causation, but have been recognized by empirical correlation.

In the example of a patient presenting high blood pressure, high cholesterol and diabetes, these co-morbid conditions are not generally considered to have the same source, but these conditions do share at least some underlying causative factors. Such factors may include, for example, poor dietary habits including high-fat content, calories ingested in substantial excess of calories expended, smoking, high alcohol consumption, etc. Regardless the source, these co-morbid conditions frequently occur, at least in North America. Thus, it would be helpful to have a medication capable of treating a number of the manifestations of these co-morbid conditions in a minimum number of doses. This embodiment of the present invention is described in terms of these co-morbid conditions, but it should be understood that this description is exemplary only and does not limit the scope of the invention.

For example, a patient presenting with the co-morbid conditions high blood pressure (hypertension), high cholesterol and diabetes is likely to be treated with one or more agents for reducing the blood pressure, one or more agents for reducing total cholesterol, for reducing LDL, and/or for increasing HDL, and one or more agents for treating the diabetes, such as insulin and/or a sulfonylurea compound. In the prior art, such a patient would have a multitude of separate prescription medications to take, each one potentially on a somewhat different dosing schedule, each one having to be prescribed, filled, stored, and then selected for administration at the proper time. As noted above, such prior art methods are fraught with possible error, unnecessary expense and complexity and inconvenience for all concerned.

In accordance with the present invention, one medicament, or in some cases, a small number of medicaments, may be prepared according the method described herein. Thus, in this embodiment, data such as that described above is obtained and utilized to carry out the steps of identifying at least two co-morbid conditions, for which a plurality of distinct active ingredients may be prescribed for substantially simultaneous treatment of the at least two co-morbid conditions;

and from the data determining a combination of at least two of the plurality of distinct active ingredients commonly prescribed for treatment of the at least two co-morbid conditions, in which the combination may be taken together for treatment of the at least two co-morbid conditions. Based also on the data and the experience of the practitioner, an effective dosage and content ratio of each of the distinct active ingredients in the combination is determined. Thereafter, the medicament is prepared, for example as follows.

For treatment of hypercholesterolemia, atorvastatin, under the trademark LIPITOR®, is provided in dosages of 10 mg, 20 mg, 40 mg and 80 mg, usually taken once a day. For treatment of the hypertension, captopril, under the trademark CAPOTEN®, is provided in dosages of 12.5 mg, 25 mg, 50 mg, and 100 mg, usually taken two or three times a day. For treatment of diabetes, glimepiride, under the trademark AMARYL®, is a sulfonylurea for patients with type 2 diabetes, is usually taken once a day with the first main meal, in a 1 mg to 4 mg dosage.

In an exemplary embodiment of the medicament combining these active ingredients, a single dose containing 20 mg. of atorvastatin, 50 mg. or captopril, and 2 mg. of glimepiride is formed. In one embodiment, the amount of captopril can be adjusted as need be to compensate for its usual multiple daily doses since the other two active ingredients are normally taken once a day. In another embodiment, two daily dosage forms of the medicament are prepared, and are, for example, color coded, in which one daily dosage form contains all three medicaments and the other daily dosage form contains only the captopril. While this embodiment requires the preparation of two versions of the medicament, it is nevertheless a reduction and simplification for the patient and all concerned, as compared to the prior art in which all three active ingredients would be separately packaged, etc.

As should be clear to those of skill in the art based on the foregoing, as the number of co-morbid conditions increases, the benefits of the present invention increase.

In one embodiment, all of the active ingredients in this embodiment of the method are prescription-only pharmaceutical agents. In another embodiment, a plurality of the active ingredients in this embodiment of the method are prescription-only pharmaceutical agents. In another embodiment, at least one of the active ingredients in this embodiment of the method are prescription-only pharmaceutical agents.

The following co-morbid conditions together with potential active ingredient combinations for treatment are provided in the following.

a. Depression, urinary incontinence, irritable bowel syndrome and fecal incontinence can be treated with a combination of TOFRANIL® and COLACE®.

b. Diabetes mellitus and hypertension can be treated with glucophage and a calcium channel blocker in many persons.

c. Herniated lower lumbar disc syndrome, including manifestations such as those discussed in the first example above, also can be treated as follows: pain: narcotic pain medication (oxycodone); muscle spasms: skeletal muscle relaxant (quinine, cyclobenzaprine, clonazepam); irritable bowel disease: (imipramine, COLACE®); fecal incontinence: (imipramine, COLACE®); urinary urgency with post-void incontinence: (imipramine, COLACE®); erectile dysfunction (CIALIS®), depression and insomnia: (imipramine, COLACE®).

Additional exemplary co-morbid conditions which can potentially be treated according to the present invention include, but are not limited to:

Hypertension

Congestive heart disease

Coronary artery disease

Hypercholesterolemia

Hyperlipidemia

Hypothyroidism

Myasthenia gravis

Parkinson's disease

Urinary incontinence

Fecal incontinence

Irritable bowel syndrome of all types

Bradycardia

Influenza

Cardiac arrhythmias

Diabetes mellitus

Diabetes insipidus

Osteopenia

Osteoporosis

Osteoarthritis

Collagen vascular diseases

Asthma

Cystic fibrosis

Multiple sclerosis

Peptic ulcer

Gastroesophageal reflux

Lupus

HIV/AIDS

Dermatitis

Vasculitis

Asbestosis

Black lung disease

Musculoskeletal injury

Drug addiction

Alcoholism

Psychiatric disorders

Systemic fungal infections

Lyme disease

Dementia

Pancreatitis

Leukemia all types

Cancer solid tumor all types

Crohn's disease

Familial polyposis

In an embodiment of the method of the present invention, by preparing the medicament comprising the combination, a synergistic effect is obtained, in that the dosage of one or more of the distinct active ingredients in the combination can be reduced relative to the amount of that distinct active ingredient if used in the absence of the other distinct active ingredients in the combination. For example, in one embodiment, using the examples set forth above, due to the use of the anti-cholesterol drug, the quantity of anti-hypertensive needed to obtain the desired effect can be reduced. In the absence of the anti-cholesterol drug, additional anti-hypertensive may be required. Although not to be bound by theory, this is thought to be the result of the contribution of cholesterol to hypertension. Combining the dosages of anti-cholesterol drug and anti-hypertensive can reduce the total quantity of medicament which must be administered, thus constituting a synergistic effect. Similar effects are believed to result from the combination of additional ingredients, such as those exemplified above.

In one embodiment, the method further includes using the prepared medicament for treating at least one patient presenting the at least two co-morbid conditions, monitoring response of the at least one patient and repeating one or more of the preceding steps. Thus, based on the experience of the practitioner in the practice of the invention, the method can be repeated and the medicament further refined by, e.g., adjusting the dosages and/or content ratios of the active ingredients. for example, it may be found that a given combination provides a synergistic effect, and that a lower dosage of one or more of the active ingredients in the combination can be reduced. In that case, the medicament may be reformulated. On the other hand, it may be found that there is an unexpected adverse effect resulting from interactions between two ingredients, which had not been previously recognized. In this case as well, the medicament may be reformulated.

Medicaments

In one embodiment, the present invention relates to a medicament, including a plurality of active ingredients. In one embodiment, at least two of the plurality of active ingredients are prescribed for separate co-morbid conditions, in which each of the plurality of active ingredients is provided in an effective dosage and content ratio effective to treat the separate co-morbid conditions in a patient presenting the co-morbid conditions. Exemplary medicaments have been described in the foregoing. In one embodiment, the plurality of active ingredients includes at least two active ingredients. In another embodiment, the plurality of active ingredients includes at least three active ingredients. In another embodiment, the plurality of active ingredients includes at least four active ingredients. In another embodiment, the plurality of active ingredients includes from three to ten active ingredients. As noted above, some or all of the active ingredients may be prescription-only pharmaceuticals.

In another embodiment, the present invention relates to a medicament including a plurality of prescription-only active ingredients, wherein at least two of the plurality of active ingredients are prescribed for at least one condition comprising a plurality of manifestations, wherein each of the plurality of active ingredients is provided in an effective dosage and content ratio effective to treat the separate manifestations in a patient presenting the at least one condition comprising a plurality of manifestations.

In one embodiment, the plurality of active ingredients is provided in a co-packaged form, in which a single package comprises a plurality of dosages or dosage forms. In one such embodiment, the co-packaged dosages comprise a plurality of identical doses. In another such embodiment, the co-packaged dosages comprise a plurality to non-identical doses, in which two or more different dosage forms are included together. In one such embodiment, the two or more dosage forms have the same form as in tablet, liquid, gel, gelcap, etc., but have different and/or distinct formulations. In another such embodiment, the two or more dosage forms have a combination of such forms.

Combining medications into a new product(s) has advantages for the consumer and the manufacturer. The manufacturer may utilize prior basic and clinical research of the component active ingredients to expedite their new product(s) to market and save development time, as well as research and development costs. The consumer will benefit from more widespread use of a product which will detect adverse drug reactions in a larger effective patient population over a period of years. The consumer who has come to rely on the safety and efficacy of a component medication will be able to obtain a continuous source of the medication albeit perhaps only in a new combination medication product. Lower research and development costs equate with improved consumer and manufacturer economics. This invention does not extend to existing multi-component medications nor does it extend to different proportions of component ingredients in existing multi-component medications. In one embodiment, this invention includes combinations of new drug(s) and older drug(s) (e.g., those with at least a five year use history, as discussed above) into a new combination drug therapy. In one embodiment, this invention includes combinations of older drugs into a new combination drug therapy. In one embodiment, more than one simultaneous route of a administration is included within the scope of this invention.

In one embodiment, the active ingredients in this invention may be combined with or may include one or more compounds selected from a hormone, an herb, a mineral, a vitamin, an over-the-counter (OTC) product, and/or a laxative.

In one embodiment, the at least one morbid condition includes congenital and/or acquired conditions in mammals. In general, this invention is applicable to all mammals.

In one embodiment, this invention may be considered to include “bundling” of existing safe and efficacious medications into new products with proven safely profiles and substantial overall market utilization. Consumers will benefit from availability of component ingredients which serve them well in discrete form. Consumers will benefit from a lower burden of research and development costs. Manufacturers will benefit from the potential for a myriad of new combination products where each such combination will enjoy a period of patent protection. The new combinations disclosed herein are distinct products themselves, providing more treatment features or effects at a lower overall cost to the consumer, as described in detail in the foregoing. In one embodiment, a beneficial feature of the invention is a lower overall cost to the end-user or third party payer. The disclosed and claimed medicament's cost to the end-user is expected to be less than the summation of the component medications which comprise the new product(s). In one embodiment, this invention includes combinations where more than one route of administration may be included. For example, one oral component, one suppository and a nasal spray all co-packaged and/or administered substantially at the same time or strategically timed in relationship to the administration of the other component(s), are included within the scope of the invention.

In one embodiment, the present invention, providing a medicament and a method of making the medicament, provides a means and method for bridging co-morbid conditions. That is, the medicament may be used to treat co-morbid conditions, thus bridging the conditions by treating them with a single medicament. Thus, the present invention represents a significant advance, in that a patient presenting co-morbid conditions can be treated as a whole, rather than by treating the symptoms individually or not at all, due to a failure to recognize connections between co-morbid conditions.

Throughout the foregoing specification, dosage forms, amounts and regimens of the various active ingredients have been described primarily in terms of presently existing products in which these active ingredients are included. It is to be understood that when these various active ingredients are employed in the present invention, that the dosage forms, amounts and regimens, including amounts administered in any individual dosage, may be changed and adjusted as needed to correspond to the uses described herein. Persons of ordinary skill in the art can determine appropriate dosage forms, amounts and regimens based on the foregoing specification and the knowledge of such persons.

In various embodiments, this invention includes new drug combinations including as active ingredients one or more of the following drugs:

ibuprofen

celecoxib

piroxicam

hydrocodone

oxycodone

propoxyphene

morphine

pentazocine

tramadol

carisoprodol

cyclobenzaprine

quinine

diazepam

clonazepam

nortriptyline

zolpidem

Benadryl

buspirone

dioctyl sodium sulfosuccinate

temazepam

imipramine

amitriptyline

doxepin

cimetidine

It is noted that, throughout the specification and claims, the numerical limits of the disclosed ranges and ratios may be combined, and are deemed to include all intervening values. Furthermore, all numerical values are deemed to be preceded by the modifier “about”, whether or not this term is specifically stated.

While the principles of the invention have been explained in relation to certain particular embodiments, and are provided for purposes of illustration, it is to be understood that various modifications thereof will become apparent to those skilled in the art upon reading the specification. Therefore, it is to be understood that the invention disclosed herein is intended to cover such modifications as fall within the scope of the appended claims. The scope of the invention is limited only by the scope of the claims.

1. A method of making a medicament, comprising:
identifying at least one morbid condition including a plurality of manifestations for which a plurality of distinct active ingredients may be prescribed for treatment of each of the respective plurality of manifestations;
determining a combination of at least two of the plurality of distinct active ingredients prescribed for treatment of each of the at least one condition, in which the combination may be taken together for such treatment of the respective plurality of manifestations;
determining an effective dosage and content ratio of each of the distinct active ingredients in the combination; and
preparing a medicament comprising the combination, wherein a ratio of each distinct active ingredient in the medicament substantially corresponds to the determined effective dosage and content ratio.

2. The method of claim 1 wherein the step of identifying comprises (a) polling a plurality of practitioners for relevant information, (b) reviewing a database containing relevant information, or a combination of one or more of both (a) and (b), wherein the relevant information relates to identity of the at least one active ingredient, either or both of the at least two co-morbid conditions, the dosage of each at least one active ingredient and any interactions between any combination of the at least one active ingredient.

3. The method of claim 2 wherein the step of identifying comprises applying a statistical and/or mathematical algorithm to the relevant information obtained from (a) and/or (b).

4. The method of claim 2 wherein the practitioners comprise one or more of medical practitioners, physicians, surgeons, retail pharmacists, wholesale pharmacists, pharmacologists, and hospital administrators.

5. The method of claim 1 wherein the plurality of active ingredients include members effective for treatment of each of the plurality of manifestations related to or co-occurring in the at least one condition.

6. The method of claim 1 wherein the step of determining a combination comprises selecting at least one member of a group of active ingredients effective for treatment of at least one of the plurality of manifestations related to or co-occurring in the at least one condition.

7. The method of claim 1 wherein the step of determining an effective dosage and content ratio comprises reviewing dosage data for each active ingredient used for treatment of each respective manifestation, obtaining information on effective dosage for treatment of each respective manifestation, analyzing the dosage data to obtain the average, mean and/or mode of dosages commonly prescribed for treatment of each respective manifestation, comparing the dosage data for each active ingredient in the combination, and obtaining the content ratio for the plurality of active ingredients.

8. The method of claim 1 wherein the preparing a medicament comprises combining a quantity of each of the plurality of active ingredients substantially corresponding to the determined effective dosage and content ratio.

9. The method of claim 1 wherein the step of identifying includes identifying at least two co-morbid conditions, each comprising at least one manifestation.

10. The method of claim 1 wherein at least one of the active ingredients has at least a five year history of clinical use for treatment of at least one of the plurality of manifestations.

11. The method of claim 1 further comprising using the prepared medicament for treating at least one patient presenting the at least one morbid condition, monitoring response of the at least one patient and repeating one or more of the preceding steps.

12. A method of making a medicament, comprising:
identifying at least two co-morbid conditions for which a plurality of distinct active ingredients may be prescribed for substantially simultaneous treatment of the at least two co-morbid conditions;
determining a combination of at least two of the plurality of distinct active ingredients commonly prescribed for treatment of the at least two co-morbid conditions, in which the combination may be taken together for treatment of the at least two co-morbid conditions;
determining an effective dosage and content ratio of each of the distinct active ingredients in the combination; and
preparing a medicament comprising the combination, wherein a ratio of each distinct active ingredient in the medicament substantially corresponds to the determined effective dosage and content ratio.

13. The method of claim 12 wherein the step of identifying comprises (a) polling a plurality of practitioners for relevant information, (b) reviewing a database containing relevant information, or a combination of one or more of both (a) and (b), wherein the relevant information relates to one or more of the identity of the at least one active ingredient, either or both of the at least two co-morbid conditions, the dosage of each at least one active ingredient and any interactions between any combination of the at least one active ingredient.

14. The method of claim 13 wherein the step of identifying comprises applying a statistical and/or mathematical algorithm to the relevant information obtained from (a) and/or (b).

15. The method of claim 13 wherein the practitioners comprise one or more of medical practitioners, physicians, surgeons, retail pharmacists, wholesale pharmacists, pharmacologists, and hospital administrators.

16. The method of claim 12 wherein the plurality of active ingredients include members effective for treatment of each of the at least two co-morbid conditions.

17. The method of claim 12 wherein the step of determining a combination comprises selecting at least one member of a group of active ingredients effective for treatment of at least one of the at least two co-morbid conditions.

18. The method of claim 12 wherein the step of determining an effective dosage and content ratio comprises reviewing dosage data for each active ingredient used separately for treatment of each of the at least two co-morbid conditions, obtaining information on effective dosage used separately for treatment of each respective co-morbid condition, analyzing the dosage data to obtain the average, mean and/or mode of dosages commonly prescribed separately for treatment of each respective co-morbid condition, comparing the dosage data for each active ingredient in the combination, and obtaining the content ratio for the plurality of active ingredients.

19. The method of claim 12 wherein the preparing a medicament comprises combining a quantity of each of the plurality of active ingredients substantially corresponding to the determined effective dosage and content ratio.

20. The method of claim 12 wherein the step of identifying includes identifying a plurality of manifestations of at least one of the two co-morbid conditions.

21. The method of claim 12 wherein at least one of the active ingredients has at least a five year history of clinical use for treatment of at least one of the co-morbid conditions.

22. The method of claim 12 further comprising using the prepared medicament for treating at least one patient presenting the at least two co-morbid conditions, monitoring response of the at least one patient and repeating one or more of the preceding steps.

23. A medicament, comprising a plurality of active ingredients, wherein at least two of the plurality of active ingredients are prescribed for separate co-morbid conditions, wherein each of the plurality of active ingredients is provided in an effective dosage and content ratio effective to treat the separate co-morbid conditions in a patient presenting the co-morbid conditions.

24. The medicament of claim 23 wherein the medicament comprises a quantity of each of the plurality of active ingredients substantially corresponding to an effective dosage of each active ingredient for use in treating each separate co-morbid condition.

25. The medicament of claim 23 wherein at least one of the active ingredients has at least a five year history of clinical use for treatment of at least one of the co-morbid conditions.

26. The medicament of claim 23 wherein each of the active ingredients has at least a five year history of clinical use for treatment of at least one of the co-morbid conditions.

27. The medicament of claim 23 wherein the co-morbid conditions can occur separately but occur together in a population of patients for which the medicament may be prescribed.

28. A medicament, comprising a plurality of prescription-only active ingredients, wherein at least two of the plurality of active ingredients are prescribed for at least one condition comprising a plurality of manifestations, wherein each of the plurality of active ingredients is provided in an effective dosage and content ratio effective to treat the separate manifestations in a patient presenting the at least one condition comprising a plurality of manifestations.

29. The medicament of claim 28 wherein the medicament comprises a quantity of each of the plurality of active ingredients substantially corresponding to an effective dosage of each active ingredient for use in treating each separate manifestation.

30. The medicament of claim 28 wherein at least one of the active ingredients has at least a five year history of clinical use for treatment of at least one of the manifestations.

31. The medicament of claim 28 wherein each of the active ingredients has at least a five year history of clinical use for treatment of at least one of the manifestations.

32. The medicament of claim 28 wherein the manifestations can occur separately but occur together in a population of patients for which the medicament may be prescribed.

33. The medicament of claim 23 wherein the plurality of active ingredients is provided in a co-packaged form, in which a single package comprises a plurality of dosages or dosage forms.

34. The medicament of claim 28 wherein the plurality of active ingredients is provided in a co-packaged form, in which a single package comprises a plurality of dosages or dosage forms.
